(19) United States
(12) Patent Application Publication
(10) Pub. No.: US 2010/0166533 A1
(43) Pub. Date: Jul. 1, 2010

(54) System for efficiently transporting large quantities of initially, loose pieces of scrap sheet metal

(75) Inventor: Alfred George Hering, Plymouth, MI (US)

Correspondence Address: Bernard J. Cantor, 5685 Forman Drive, Bloomfield Hills, MI, 48301-1154, US

(73) Assignee: Soave Enterprises L.L.C.

(21) Appl. No.: 12/317,885

(22) Filed: Dec. 31, 2008

(51) Int. Cl. B66C 1/04; B66C 23/18

(52) U.S. Cl. 414/728; 414/737; 414/815; 414/787

(57) ABSTRACT

This invention relates to a system for efficiently transporting large quantities of initially loose pieces of irregularly shaped scrap sheet metal by temporarily compressing batches of such pieces together into unitary slabs and then forming stacks of numerous slabs, arranged in closely fitted rows within open-top railroad cars or truck trailers. Each slab is formed by ramming a batch of pieces against a vertical plate so that the slab is generally vertically arranged. The slab is then allowed to gravity-fall upon a downwardly tilted table. A second slab is formed and similarly allowed to fall on the table in end-to-end contact with the first slab. The table is then tilted into a horizontal position. A horizontal magnet is positioned to overlap and engage both slabs simultaneously. The magnet is supported by a crane which lifts and moves the magnet over the open-top railroad car or truck and deposits the pair of slabs into an adjacent pair of stacks. The successive stacks are arranged in closely positioned rows for substantially filling the car or trailer which then transports the slabs to a recycling location.

### BACKGROUND OF INVENTION

This invention relates to equipment and a method for providing a system for economically and efficiently moving large quantities of irregularly shaped, multiply bent, pieces of scrap sheet metal from an initial location, such as from a factory, in which the scrap is generated during the production of products from sheet metal, to a remote facility. During the manufacture of products from sheet metal by a process that involves stamping the product from a larger, generally flat, sheet of a ferrous metal material, large quantities of scrap pieces are produced. These pieces, such as trim or punched or bent pieces, tend to quickly accumulate in large quantity particularly in manufacturing plants in which large quantities of articles are produced. For example, during the manufacture of stamped sheet metal automobile body parts, there are large quantities of scrap trim or excess material surrounding the stamped parts. These scrap pieces generally are irregular in shape and frequently multiply bent so that they are difficult to handle. When collected together in a container these scrap pieces occupy considerable volume, most of which is empty space because of the spaces between the irregular shapes and forms of adjacent pieces.

Various efforts have been made to recycle these scrap metal pieces, usually by conveying the pieces to a recycling melt furnace where the scrap pieces are melted and ultimately reformed into new sheets. However, stamping plants where the scrap pieces are generated, usually are remote from the recycling facilities where the parts are melted in suitable furnaces. Hence, it is usually necessary to transport the. scrap pieces considered distances from the generating location to the recycling facility.

Usual shipping methods involve the use of open-top railroad freight cars or open-top truck trailers into which large quantities of scrap pieces are dumped for transportation. Also, large container boxes have been used for containing such pieces with the boxes carried upon flatbed railroad cars or truck trailers. Typically, the transportation containers, whether truck trailers or railroad cars or large boxes, are capable of carrying considerably more weight of metal scrap than can be placed within each container when the individual pieces are loose. Hence, it is desirable to compact the pieces tightly together so as to utilize the maximum amount of the volumetric capacity of the shipping container. The more the container carries, up to its maximum weight, the greater the savings in the cost of shipping.

Thus, techniques and machinery have been developed for compressing loose pieces of scrap sheet metal into large bales or wafers which reduce the volume of space for moving large quantities of pieces.

An example of a system for compacting loose pieces is disclosed in U.S. Pat. No. 7,377,214-B2, issued May 27, 2008 to Donald R. Schomisch and Jonathan A. Little, entitled “Apparatus and Method for Temporarily Compressing Loose, Multiply Bent Pieces of Scrap Sheet Metal into Compacted Wafers.” That patent discloses equipment wherein loose pieces of scrap sheet metal are dropped into a compression chamber and then rammed by a reciprocal ram against an anvil-like door for compressing the batch of loose pieces together into compressed wafers. The wafers are discharged from the compression chamber and dropped into transportation containers for moving the wafers to a recycling facility for melting the scrap and forming new metal sheets. As illustrated in the patent, the wavers leaving the compression chamber, are dumped, helter-skelter into the container. That leaves considerable volumes of empty spaces between the wafers so that each container is not filled to its maximum weight carrying capacity. Hence, when the container travels to the recycling facility, although it may appear to be full, actually it does not hold the amount of material that it could hold.

Another example of a process and equipment for transporting loose pieces of scrap metal is disclosed in U.S. Published Application No. 2008/0156205-A1, published Jul. 3, 2008, entitled “Method for Transporting Bent Irregularly Shaped Pieces of Scrap Sheet Metal,” by Alfred George Hering. Here too, batches of the scrap sheet metal pieces are placed into a compression chamber where the batches are rammed against a vertically positioned door or anvil to form a vertically arranged wafer or slab of compressed sheet metal. The compressed wafers are pushed out of the chamber, when the door is lifted, and dropped into a transportation container which carries the wafers to the recycling facility. There the wafers may be unloaded and dropped into a melt furnace or into a pile for later moving into the furnace. The wafers are disassembled into their separate pieces so that the melt furnace receives separated pieces.

A major handling problem that arises when compacted wafers or bales are transported involves efficiently loading the transportation containers, whether a railroad car or a truck trailer, up to the maximum weight carrying capacity of the container. It is desirable to load the containers swiftly, with minimal handling and minimal labor, in order to reduce the transportation and labor costs and consequently the overall cost of recycling the metal.

Thus, the present invention is concerned with providing a system for handling heavy slabs formed of compressed together scrap sheet metal pieces, and for efficiently loading a shipping container, such as railroad freight cars or truck trailers as fully as is possible within the weight limits of the containers. This system contemplates efficiently forming and automatically placing compressed slabs in closely packed stacks and rows of slabs within the containers. Rather than merely dumping the slabs, stacking the slabs into stacks and rows of stacks avoids spaces between them as well as avoids possible shifting of the cargos during movement of the containers.

### SUMMARY OF INVENTION

This invention is essentially concerned with equipment and methods for efficiently converting very large quantities of loose, irregularly shaped and bent pieces of scrap metal into tightly compacted slabs which are automatically transmitted from compression equipment into cargo shipping containers, such as conventional railroad cars or trailers or the like, and automatically packed within such containers in a way that uses virtually all of the available volume of the container. In general, the equipment comprises a compressor which receives batches of large quantities of scrap sheets which are rammed against a vertical plate or base to form upright, relatively thin, but large and wide, slabs. These slabs, when the plate is moved away, tip or tumble out of the compressor upon a table. The table is normally sloped downwardly so that each slab slides down the table a short distance. Then, a second slab is formed and is tipped over onto the table into end-to-end contact with the original slab. This forms a pair of adjacent, end-to-end, slabs.

After the two slabs are positioned upon the sloped table, the table is pivoted upwardly into a horizontal position. Then a large electromagnet is arranged over the slabs. Preferably the magnet is of a size and shape to substantially cover both slabs simultaneously. The magnet is suspended from an overhead crane so that when the magnet attaches to the pair of slabs, the slabs are lifted upwardly from the table. The table then returns back to its sloped position. Simultaneously, the magnet is moved by the crane, laterally of the table over the open top of a railroad car or trailer or other similar container. The magnet is then lowered to position the pair of slabs neatly within the container. By repeating the cycle, stacks of slabs are formed in the container. Another stack is formed along the side of the first stack. Then, by moving the container forwardly, such as by indexing a railroad car along the track the distance equivalent to the length of a pair of stacks, the process is repeated so that adjacent rows of stacks are formed along the length of the container. Hence, the container is completely filled by the rows of stacks, with virtually no empty spaces between the stacks up to the maximum weight carrying capacity of the container. In the case of a railroad car, filling the entire car close to the level of its open top normally would be within the weight carrying capacity of the car.

The container may then be transported, such as by rail if a railroad car, or by highway if a truck, to a recycling facility. There, the stacks may be unloaded by utilizing a similar magnetic and crane system for placing the slabs upon the ground for storage or for moving the individual slabs directly into a conventional melt furnace. The slabs may be disassembled at the furnace by applying a sufficient impact force and preferably some vibration forces to the slabs to shake the constituent parts thereof apart so that they individually fall into a molten pool of metal in the furnace.

A major object of this invention is to provide a system by which the loose pieces of scrap sheet metal are compacted together into unitary, heavy slabs which are closely stacked into shipping containers, preferably by an automatic system involving minimal labor and time for the loading process. Since the stacking enables shipping containers that are loaded close to their maximum weight carrying capacity, the number of containers, such as railroad cars or the like, is reduced to a minimum. Also, the system may be operated automatically so that the labor costs are substantially reduced.

Again, an object of this invention is to substantially reduce the cost of handling and transporting the scrap metal generated in a typical sheet metal processing plant where the scrap material is to be recycled at a remote location, by reducing the expense of handling the material between the point where it is generated to the point where it is transferred to the recycling facility.

Another object is to facilitate the loading of railroad cars or trailer trucks with the scrap metal generated at a large volume sheet metal manufacturing facility and especially to enable the loading to proceed automatically, around the clock, with virtually no human labor required.

An additional object of this system is to provide for continuous, that is, uninterrupted, flow of scrap pieces to the compressor from the generating source, while intermittently ramming predetermined size batches in the compression chamber by temporarily accumulating incoming scrap pieces upon the upper surface of the ram as the ram moves forwardly to compress a batch within the compression area, and then automatically dropping the accumulate pieces into the compression area as the ram is retracted.

These and other objects and advantages of this invention will become apparent upon reading the following description, of which the attached drawings form a part. Now, referring to the drawings:

### DESCRIPTION OF DRAWINGS

FIG. 1 is a perspective, schematic view of the system.

FIG. 2 is a plan, schematic view of the system.

FIG. 3 is an enlarged schematic, elevational view of the compressor, discharge table and magnetic crane.

FIG. 4 is an enlarged, schematic view of the ram and compressor chamber.

FIG. 5 is a perspective view of a complete compressed slab.

FIG. 6 is a schematic plan view of a railroad freight car loaded with slabs.

FIG. 7 is an elevational view of the freight car, shown schematically and in cross-section indicating the typical row of stacked slabs.

FIG. 8 is a perspective view of the ram and its top cover sheet which receives and temporarily holds incoming loose pieces of sheet metal when the ram moves forwardly.

FIG. 9 schematically is illustrating the sequential steps 1-9 of a cycle of the operation of the system.

### DETAILED DESCRIPTION

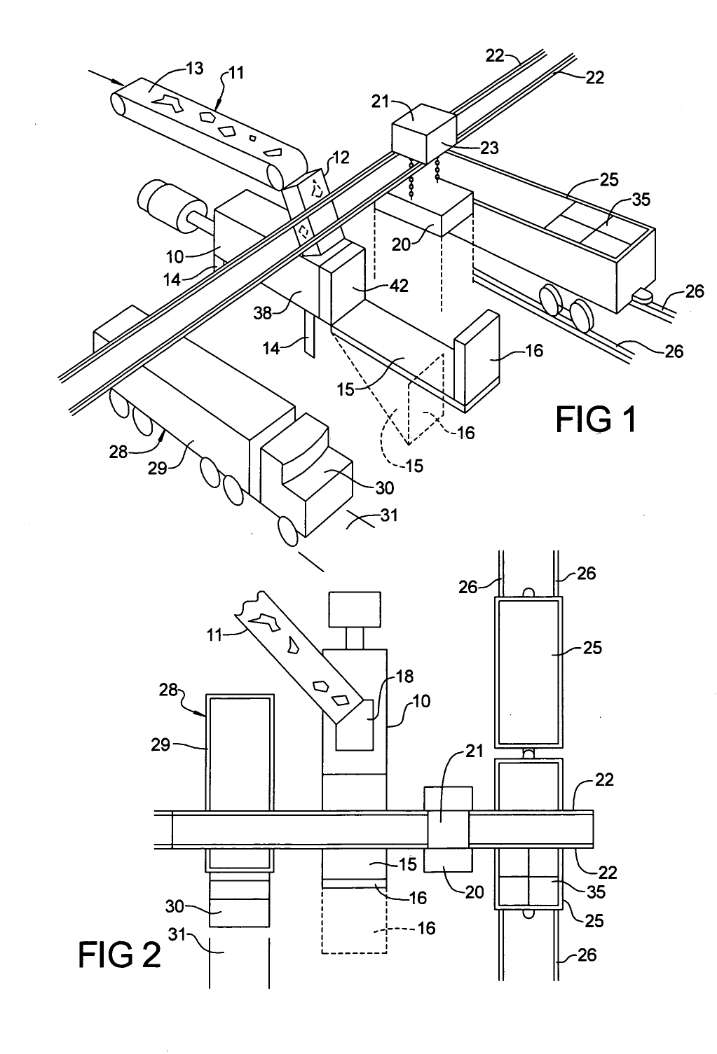

FIG. 1 illustrates, schematically, the overall system and its components. The system includes a compressor 10 and a conveyor arrangement 11 which terminates in a chute 12 that continuously deliver scrap sheet metal pieces 13 from the manufacturing plant to the compressor. The compressor is schematically shown as being supported upon suitable columns or other supports 14.

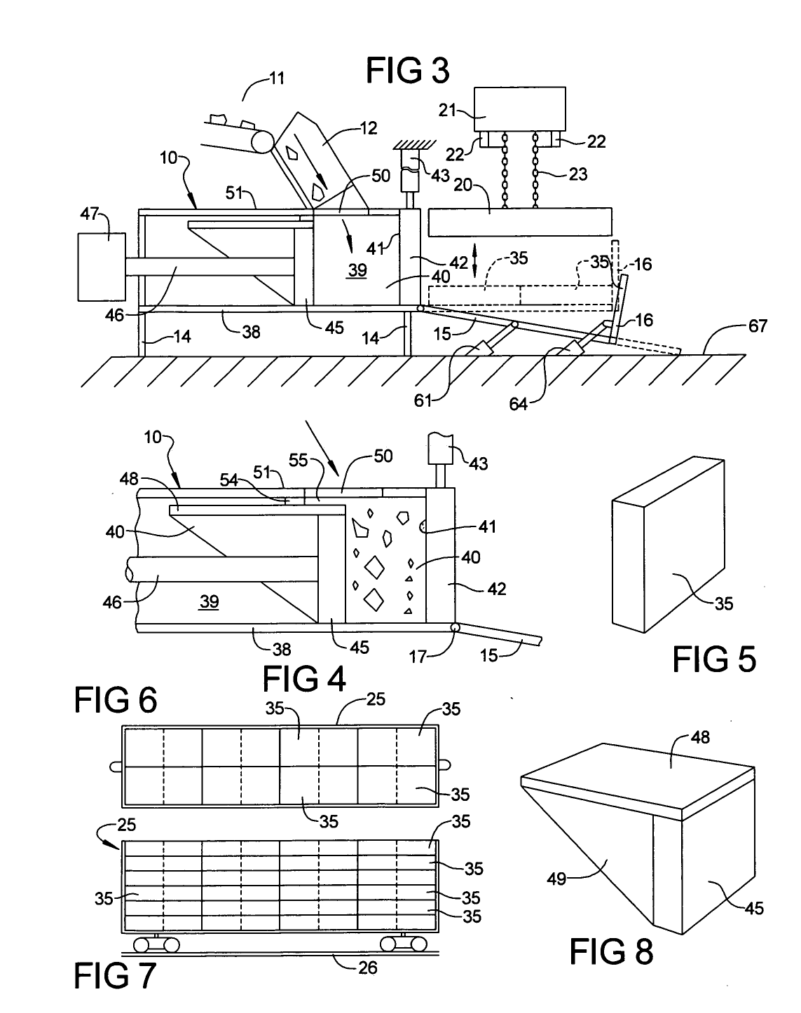

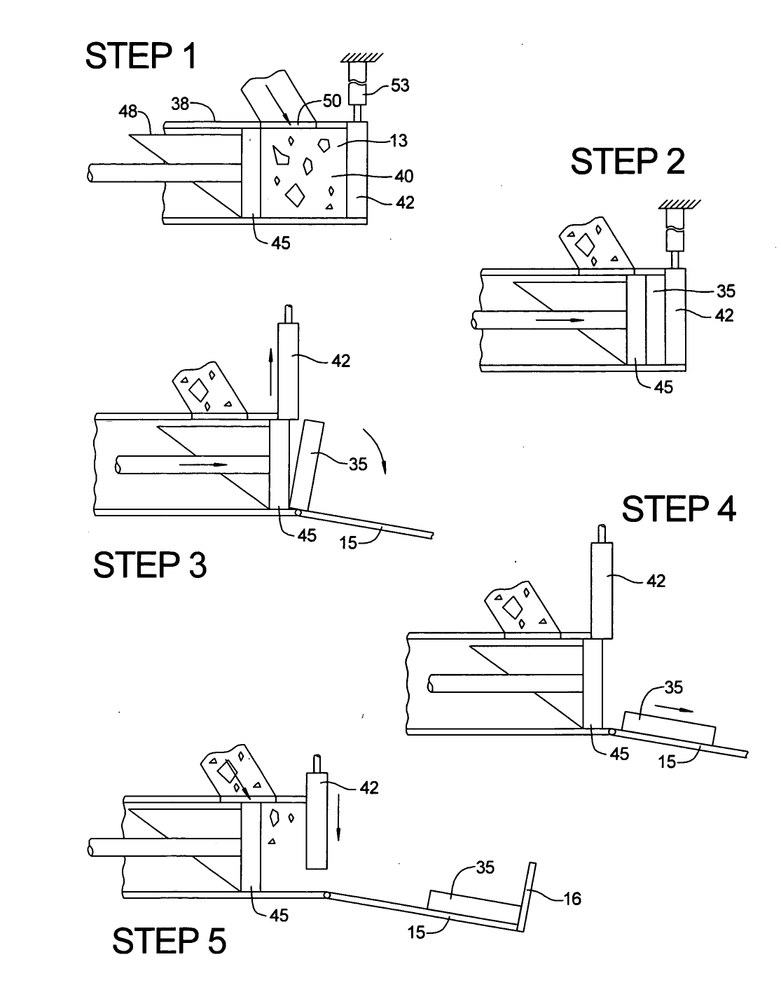

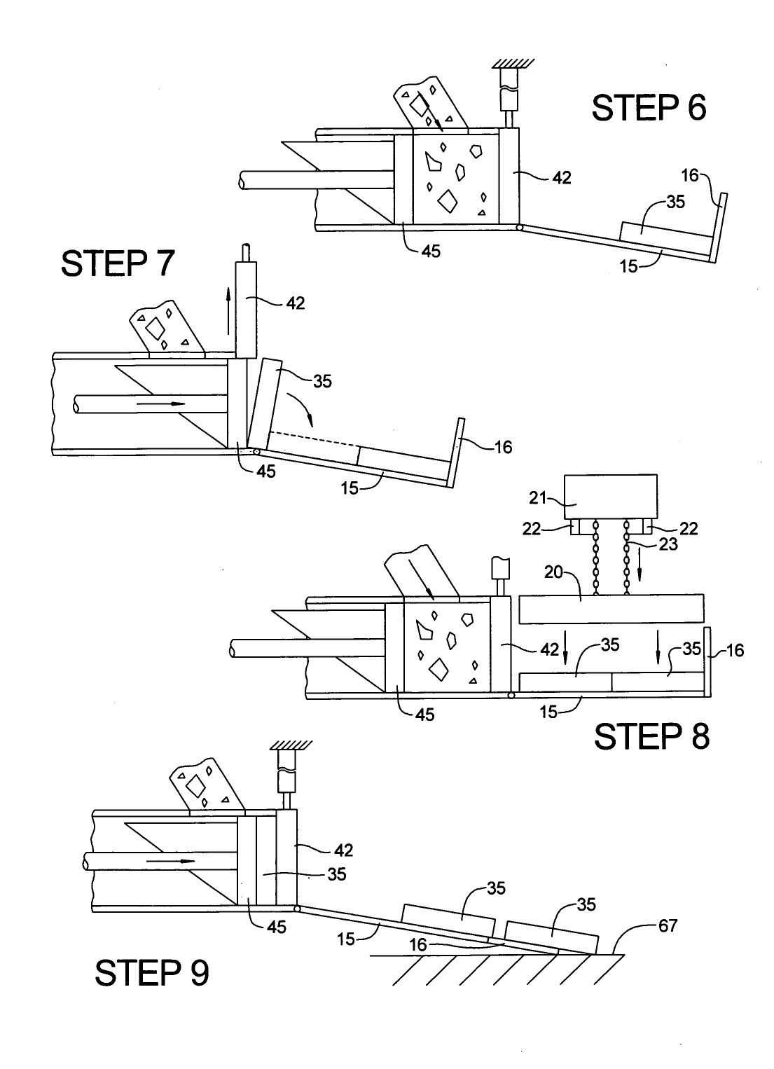

Extending forwardly of the compressor is a table or platform 15 which receives slabs that are discharged from the compressor. The table includes an end extension portion 16 which may act as a stop for slabs sliding down the table or, alternatively, as a steep, downwardly sloped, portion of the table for discharging slabs from the table. The table is normally tilted at a downward angle and can be raised into a horizontal position as indicated in dotted lines in FIG. 3. In order to tilt and raise the table, the table may be pivotally connected by a hinge arrangement 17 and lift hydraulic components.

Returning to FIGS. 1 and 2, the system includes a large electromagnet 20 suspended by cables 23 from a crane mover 21 which moves laterally along tracks 22 relative to the compressor. The magnet is moved laterally with the crane mover 21. The crane mover, and the tracks and the electromagnet are commercially available equipment and, therefore, no further description is given here as various alternative parts may be utilized.

On one side, approximately parallel to the compressor and the table, is a railroad siding upon which open-top railroad freight cars move. The cars 25 travel along railroad tracks 26 and can be moved in conventional manner along the tracks beneath the crane 21 and the magnet 20.

On the opposite side of the compressor, a trailer truck 28 having an open-top conventional trailer 29, pulled by a tractor 30, rests upon a roadway 31.

In general, slabs 35, composed of numerous compressed together pieces of scrap sheet metal, are formed in the compressor initially. Then each slab falls from the compressor upon the table 15 from which it is lifted by the electromagnet and transferred into either the railroad car or the truck, as desired.

FIGS. 3 and 4 schematically illustrate the compressor construction. The compressor is formed with a housing 38 providing an interior chamber 39, a portion of which near the forward end of the housing provides a collection area 40. The chamber has an open forward or discharge end 41, which is normally closed by a heavy, upwardly and downwardly moveable closure or backing plate 42. The backing plate or closure is mounted for upward sliding movement to thereby clear the opening for the discharge of a slab, or alternatively for downward movement for closing the opening. When down, the plate serves as a base or backing plate for the ram 45 which presses the pieces of sheet metal into a unitary slab 35. A suitable, conventional or commercially available lift mechanism 43 is provided for raising and lowering the closure 42. Conventional hydraulic cylinders, pistons and piston rods would be used for raising and lowering the closure in response to suitable controls.

The horizontally reciprocating ram 45, which is driven by a horizontally arranged ram rod 46, is arranged within the housing. The rod extends to the rear of the chamber 39 and is powered by a conventional hydraulic power system 47.

A horizontal cover sheet or plate 48 is secured to the ram and extends rearwardly therefrom. Side braces 49 made of roughly triangularly shaped metal plates rigidify the ram and horizontal plate 48.

The housing 38 is provided with an inlet or feed opening 50 located in the upper wall 51 above the collection area 40. Scrap metal pieces 13 are fed or poured through the opening into the collection area of the compressor interior chamber. During forward movement of the ram for ramming pieces of sheet metal against the backing plate, the upper horizontal plate of the ram closes the feed opening of the compressor. However, the conveyor system 11 which supplies the separated pieces 13 of sheet metal continues to operate, without stop, depositing, pieces of sheet metal upon the upper surface of the horizontal sheet 48 as the ram is moved forwardly for compressing the batches of pieces collected in the collection area against the backing plate 42. The scrap pieces may accumulate temporarily as the ram moves forwardly. Then, when the ram retracts a scraper 54 causes the accumulated pieces to drop off the ram sheet 40 into the collection area of the housing.

The backing plate or closure 42 may be raised and lowered, by a suitable hydraulic lift 43 formed of conventional hydraulic pistons, piston rods and hydraulic cylinders. Those are conventional, commercially available parts. Thus, when the closure is lifted up the loose pieces at the opening 50 are still accumulated upon the sheet 48. Thus, only when the ram is retracted, does a new batch of pieces fall into the compression area.

After a slab is formed within the compressor and closure 42 is raised, the slab is pushed outwardly through the opening 41. The slab tilts forwardly and drops down upon the downwardly sloped table or platform 15. Then the table or platform is swung upwardly (shown schematically) into a horizontal position (see FIG. 3) by means of a hydraulic lift cylinder and piston arrangement 61. While the table is tilted downwardly, for example, at approximately 20 degrees from the horizontal, the slab exiting from the compressor will fall downwardly into face-to-face contact with the upper surface of the table and then slide down the table until it hits the barrier formed by the upright table extension 16. The table extension is held upright by a suitable power device comprising a conventional hydraulic piston and piston rod and cylinder devices 64. The extension may be swung downwardly by the device so as to slope towards the ground 67 if it is desired to permit the slab to continue sliding down the table and onto the ground.

### Operation

The operation of the system is shown schematically in a series of steps, 1-9 inclusive, illustrated in FIG. 9.

Step 1 schematically illustrates the loading of scrap pieces into the compression or collection area of the compressor housing through the opening 50 in the upper wall 51 of the housing. The ram 45 at that point is retracted to allow the pieces 13 to fall into the collection area 40.

In step 2, the ram is moved forwardly towards the closure or back-up plate 42. That movement, with sufficient force, compresses the irregularly shaped, multiply bent, pieces of scrap sheet metal to bind together into a unitary slab 35. The slab is vertically arranged against the backing plate at that point.

In step 3, the backing plate or closure 42 is raised upwardly by the hydraulic lift mechanism 53, thereby clearing the opening 41 at the discharge end of the compressor chamber. The slab 35, assisted with the forward movement of the ram, moves outwardly of the opening where it tilts forwardly and downwardly to fall upon the table 15. In step 4, the slab is illustrated as lying in face-to-face contact upon the downwardly sloped table or platform. In steps 3 and 4, the ram's upper sheet blocks opening 50 to stop the feed of pieces into the collection area.

Step 5 illustrates the ram retracting toward the rear of the housing thereby unblocking the feed opening 50 in the housing and allowing scrap pieces to again fall into the collection area. While the housing opening 50 had been blocked by the horizontal sheet (step 4) scrap pieces which nevertheless were continuously fed from the conveyor system temporarily accumulate above the ram. Meanwhile, as shown in step 5, the slab 35 has slid down the table and is stopped by the upraised table extension 16. And the backing plate is lowered to close the discharge opening.

Next, step 6 shows the loading of fresh pieces of scrap in the collection and the ram preparing to move forward for the next compression stroke to form another slab.

In step 7, the second newly formed slab, is, now completed, pushed out the opening, and tilts forwardly, under gravity force, to fall flat upon the table (shown in dotted lines) and to slide down the table into end-to-end contact with the first slab. Thus, at this point there are now two slabs, arranged end-to-end on the downwardly sloped table. For example, the table may be sloped approximately 20 degrees from horizontal to implement sliding.

In step 8, the table is swung upwardly, by its lift mechanism 61, into a horizontal position with both slabs on the table arranged in end-to-end contact and horizontal. At that point, the horizontal electromagnet 20 is positioned above the pair of slabs and comes down upon them into magnetic engagement.

After the magnet engages both slabs, the magnet lifts both slabs simultaneously. Then the magnet, carrying both slabs, is moved laterally by the crane over the open-top rail car, as illustrated in FIG. 1, or laterally in the opposite direction over a truck-type trailer for loading the pair of magnets into the car or the trailer. The railroad car or truck trailer then function as a transportation container for movement to the facility where the metal will be recycled.

In the event that neither a railroad car nor truck is available at a particular moment when the pair of slabs are on the horizontally-arranged table, the table may be slanted downwardly forwardly again, perhaps to a further angle of 30 degrees, and its table extension 16 will likewise be swung into a downwardly angled position so that the slabs will slide downwardly off the table entirely and land on the ground 67 and remain there until removed.

The magnetic crane arranges the pairs of slabs within the container, that is, the truck trailer or the railroad car, in stacks. The stacks are arranged in parallel rows. This is illustrated in FIGS. 6 and 7 which schematically show two rows of stacks of slabs, each stack containing a number of slabs, one upon the other. The formation of the rows is accomplished by indexing or incrementally moving the rail car or truck short distances forwardly after each laterally adjacent pair of stacks is formed. Preferably, the magnet may be moved laterally but not longitudinally. Hence, the longitudinal change in positioning of the magnet relative to the containers is accomplished by incrementally moving the rail car or the truck longitudinally. That indexing movement may be done by using conventional equipment which will move a railroad car short distances or by driving a truck forwardly short distances.

The formation of the stacks of slabs and the rows of stacks almost completely fills all the space in the shipping container, whether a rail car or a trailer. By way of example, a typical railroad car has a weight-carrying limit of about 220,000 pounds. When the car is filled with the closely-fitted rows and stacks of slabs, almost that entire space is used so that close to that maximum weight limit is accomplished. In the case of a truck trailer, a typical weight limit is about 20 tons or about 40,000 pounds and that weight limit amount is closely reached by the stacks and rows of stacks.

A typical slab formed by this method may be on the order of 48 inches high, 43 inches wide and about 6-12 inches thick. A typical railroad open-top freight carrier has about 90 inches of transverse space so that two rows of slabs can be formed leaving a very small amount, such as an inch, on the sides of the rows to enable the slabs to closely fit easily into, and substantially fill, the space. The result is that there is almost no empty space in the container. This contrasts with shipping loose pieces or even loose slabs or slabs or wafers that are haphazardly dropped into the container where there are considerable empty spaces. The result is that the cost of shipping, and the number of containers, such as railroad cars or trailers, required for a particular place, is substantially reduced. Consequently the cost of transferring the scrap from its source, such as the factory where the scrap is generated, to the recycling area, such as the melt furnaces, is substantially reduced.

Significantly, the system may be controlled by conventional programmed computers to automatically perform the cycle of forming the slabs, then forming the pairs of slabs, and next moving the electromagnet for lifting and depositing the slabs in the shipping container, so that virtually no manual labor is required to operate the system. The system lends itself to be completely automatic in operation. The selection of suitable computer controls and the necessary computer programming of the controls can be done by skilled technicians from commercially available equipment. Therefore, the controls and computers and programming are not further described here since variations may be used.

The foregoing description is for an operative embodiment and best mode known to the inventor herein. Thus, having filly described at least one operative embodiment, it is desired that the foregoing description be read as merely illustrative and not in a strictly limiting sense. I now claim:

What is claimed is:

1. A system for transporting large quantities of initially loose, separated, irregularly shaped, pieces of thin scrap sheet metal comprising:
a compactor having a compactor chamber with a rear end and a forward, discharge end, for receiving a predetermined size batch of numerous loose pieces;
a horizontally reciprocatable ram arranged within the chamber for ramming the pieces against a plate covering said compactor chamber open end;
said ram being reciprocal towards said plate for forming a temporarily compacted, unitary slab arranged vertically against said place;
said plate being removable upwardly for passage of the slab through the opening so that the slab may be discharged from the chamber;
a flat table arranged beneath and at the discharge opening of the chamber, with said table normally sloping downwardly in a forward direction relative to the chamber, whereby the slab emerging from the chamber discharge opening will gravity-fall downwardly upon the table in face-to-face contact therewith and slide down the table a predetermined distance;
a magnet having a substantially flat, horizontally arranged face of a size and shape for substantially overlapping a slab resting upon the table;
a lift member connected to the table for raising the table into a horizontal plane and thereby arranging a slab on the table in a horizontal position;
a crane arranged above the magnet for lifting and moving the magnet laterally, relative to the table, above an open-top container, such as a railroad car or truck trailer arranged adjacent the table;
whereby the crane may lower the magnet with its attached slab for positioning the slab with similarly formed additional slabs in stacks, formed in rows of stacks, within such container for substantially filling the volumetric space within the container and the container may then be moved for transporting the slabs to a recycling facility.

2. A system for transporting large quantities of separated, loose, irregularly shaped pieces of scrap sheet metal as defined in claim 1 and including controls for sequentially forming slabs and depositing pairs of slabs upon said table when it is sloped downwardly with the slabs thereby arranged end-to-end;
and said magnet being of a size and shape for overlapping a pair of slabs upon the able when the table is lifted into horizontal location;
whereby the magnet simultaneously lifts and is moved by the crane, for magnet loading of the pair of slabs within the container to form pairs of stacks and subsequently rows of pairs of stacks within the container.

3. A system as defined in claim 2, and including said table being sloped downwardly at an angle which facilitates the slabs falling upon the table sliding down the table sufficiently to allow the pair of slabs to fall upon the table and engage in end-to-end contact for removal of the pair of slabs simultaneously by the magnet.

4. A system as defined in claim 3, and including said table having a forward end portion normally arranged upright for forming a stop for a slab sliding downwardly upon the table and having a second position for tilting further downwardly for enabling slabs on the table to continue sliding down the table upon a ground surface arranged forwardly of the table for receiving slabs temporarily during intervals when the slabs are not engaged by the magnet for loading into the containers.

5. A system as defined in claim 3, and including a railroad supporting track arranged along one side of the table for supporting a railroad car while filling the car with slabs, and including an indexing member for incrementally moving the car, step-by-step, for receiving slabs by the transverse movement of the magnet relative to the car into longitudinally arranged rows within the railroad car.

6. A system as defined in claim 1, and including:
said magnet having a substantially flat, horizontally arranged face of a size and shape to substantially overlap and cover the exposed face of the slab for contacting and magnetically attaching to said slab;
and said magnet being suspended from said crane, with the crane being moveable laterally, that is, sidewise, relative to the table, to move the magnet laterally of the table, when the magnet is attached to a slab, over the transportation container, for lowering the magnet and discharging the slab attached thereto, into the container.

7. A system as defined in claim 6, and including tracks running adjacent, and parallel to, one side of the table and a control for advancing a railroad car upon the track parallel to the table whereby the crane may lower the magnet into successive portions of the container for forming a row of stacked slabs within the container.

8. A method as defined for efficiently transporting large quantities of initially separated, loose, irregularly shaped pieces of scrap sheet metal from a location where such scrap pieces are initially located to a recycling facility remote therefrom, comprising repetitive cycles of:
(a) collecting a predetermined size batch of a number of pieces in a compression chamber;
(b) compressing the batch of pieces together against a vertical support plate at an end of the chamber to form a large, vertically arranged, wide, high and relatively thin slab formed of temporarily compressed together pieces;
(c) removing the plate and permitting the slab to fall, under the force of gravity, forwardly of the chamber and down upon the face of a downwardly sloped table so that the slab slides down the table a predetermined distance;
(d) moving the table into a horizontal position so that the slab is arranged in a generally horizontal plane upon the horizontally arranged table;
(e) positioning an electromagnet above the slab with the magnet substantially overlapping and engaging the slab for lifting the slab from the table;
(f) moving the magnet laterally, that is, sidewise of the table into a position above a transportation container;
(g) lowering the magnet with the slab into the container;
(h) arranging the slab within the container for forming a stack of successive slabs;
(i) repeating the cycle and forming successive stacks of slabs, side-by-side and end-to-end within the container for substantially filling the container;
whereby the filled container may be transported to a recycling facility and unloaded for recycling the scrap metal pieces.

9. A method as defined in claim 8, and including forming pairs of slabs, by forming in the compression chamber a second slab, following the formation of the first slab and its delivery upon the table;
allowing the second slab to fall upon the table and slide down the table into end-to-end contact with the first slab upon the table;
covering both slabs with said magnet for engaging and attaching both slabs, in end-to-end arrangement to the magnet;
moving the magnet with the pair of slabs attached thereto above the transportation container and positioning the slabs within the container to simultaneously form two stacks of slabs arranged end-to-end relationship;
subsequently repeating the cycle and forming the slabs within the container in two parallel rows of stacks of slabs for substantially filling the volume of the container.

10. A method as defined in claim 9, and including moving the table into horizontal alignment when the pair of slabs are supported thereon, with the magnet having a lower face arranged in horizontal relationship to the table and lowering the magnet into contact with, and substantially covering, the two slabs resting upon the table for simultaneously lifting both slabs from the table for transfer to the container.

11. A method as defined in claim 9, and including positioning a conventional open-top railroad freight car on tracks alongside of, and adjacent to, the table and moving the magnet by a crane from its position above the table to a position above the open top of the railroad car;
lowering the pair of slabs into the car for simultaneously forming a pair of stacks in end-to-end relationship within the car.

12. A system for efficiently transporting large quantities of initially loose, separated pieces of scrap sheet metal comprising:
a compressor having a horizontally arranged compression chamber having a rear end and a forward, opened discharge end with a collection area adjacent said discharge end;
a horizontally reciprocatable ram for ramming a batch of scrap pieces through the collection area and against a vertically arranged backing plate to form an upright slab of compacted-together pieces;
a conveyor system for continuously feeding scrap pieces from a source, downwardly through a feed opening located above the ram and into the collection area;
a horizontally arranged cover sheet arranged upon the ram upper portion for moving with the ram beneath, thereby temporarily closing, said feed opening as the ram moves through the collection area towards the backing plate;
whereby pieces moving downwardly through the feed opening, when the ram moves forwardly towards the backing plate land upon and are momentarily collected upon the ram cover sheet;
and a scraper member located in the chamber above the ram cover sheet for contacting and pushing pieces collected upon the ram cover sheet off the cover sheet so that the pieces fall into the collection area as the ram retracts toward the rear end of the chamber, to form a batch of pieces in the compression area;
whereby pieces are continuously fed into the compressor and batches of said pieces are intermittently formed in the collection area by the forward and rearward movements of the ram relative to the backing plate.

13. A system as set forth in claim 12, and including means for moving said backing plate upwardly immediately after a slab is formed against it by the ram, so that the slab may fall forwardly, out of the forward opening of the chamber upon a table extending forwardly of the compressor chamber.

14. A system as described in claim 13, and said table normally being arranged to slope downwardly, away from the discharge opening of the chamber so that the slab may slide downwardly upon the table away from the opening;
a lift member for raising the table into a horizontal position after a slab is located on said table;
a magnet mounted upon a crane, located above the table with the magnet having a horizontally arranged face of a size and shape corresponding to the slab size and shape for overlapping the slab and for lifting the slab upwardly off the table when the table is in horizontal position, and for conveying said slab to a transportation container arranged adjacent the table.
